(19) United States
(12) Patent Application Publication
(10) Pub. No.: US 2022/0404006 A1
(43) Pub. Date: Dec. 22, 2022

(54) Novel Splicing Type Plant Lamp

(71) Applicant: Guangzhou Natural Light Intelligent Lighting Appli, Guangzhou (CN)

(72) Inventors: Zexin ZHENG, Guangzhou (CN); Zhengbao LU, Guangzhou (CN); Xibiao XU, Guangzhou (CN); Hua ZHENG, Guangzhou (CN); Xiaojun ZHENG, Guangzhou (CN); Hailiang ZHENG, Guangzhou (CN)

(21) Appl. No.: 17/489,836

(22) Filed: Sep. 30, 2021

(30) Foreign Application Priority Data
Jun. 21, 2021 (CN) 202121386727.X
Jun. 21, 2021 (CN) 202121386781.4

(51) Int. Cl. F21V 23/06; F21V 23/02; F21V 23/00; F21S 4/28; A01G 7/04

(52) U.S. Cl. CPC F21V 23/06; F21V 23/02; F21V 23/003; F21S 4/28; A01G 7/045

(57) ABSTRACT

The present utility model discloses a novel splicing type plant lamp which is provided with a power supply body and lamp bodies electrically connected with the power supply body, wherein first electrical assemblies are disposed on end portions of two ends of the power supply body correspondingly, and second electrical assemblies electrically connected with the first electrical assemblies are disposed on two ends of the lamp bodies correspondingly. The novel splicing type plant lamp has the beneficial effects that the problems of complex assembly and difficult disassembly of the plant lamp can be effectively avoided, and the transportation cost and labor intensity are reduced, so that the disassembly and assembly efficiency of the plant lamp is improved, the working efficiency is improved, the product competitiveness of the plant lamp is improved, and the efficiency of supplementing light to plants is improved. Different lamp bars can be freely combined, for example, the lamp body disposed on one side of the power supply body is composed of three lamp bars, and the lamp body disposed on the other side of the power supply body may be composed of four lamp bars, so that the plant lamp is suitable for different use scenes.

### TECHNICAL FIELD

The present utility model relates to a plant lamp, and in particular relates to a novel splicing type plant lamp.

### BACKGROUND

Illumination is one of important factors influencing the growth and development of plants, and plant lamps are often used for adjusting illumination during planting, so as to control the growth of the plants.

An existing plant lamp mainly includes a lamp body module and a driving power box configured to control the lamp body module to emit light. The lamp body module is mostly fixedly connected to the power box through screws and the like, so that the operation during assembly and disassembly processes of the plant lamp is complex, and the convenience and the cost of transportation are affected at the same time.

Meanwhile, as the number of existing lamp bars is fixed, and a user must purchase a plurality of plant lamps if the user needs a different number of lamp bars, so that the cost is increased.

The plant lamp is a lamp for plants. The plant lamp simulates the principle that the plants need sunlight for photosynthesis, and supplements light to the plants or completely replaces the sunlight. However, in practice, the common plant lamp is quite inconvenient to assemble and disassemble, and when an irradiation position needs to be adjusted, the whole device needs to be disassembled, so that the labor intensity is increased, the working efficiency is reduced, and lamp bodies are prone to being damaged in a disassembly process. Meanwhile, when the common plant lamp is in use, the position of an existing hanging device is single, the irradiation position and the irradiation angle cannot be adjusted, and the illumination angle and the illumination range cannot be adjusted according to the characteristics of the plants, so that the common plant lamp has a small application range.

### SUMMARY

In view of the defects in the prior art, the present utility model aims to provide a novel splicing type plant lamp which solves the problems that an existing plant lamp is difficult to assemble and disassemble, high in transportation cost and the like. Meanwhile, the novel splicing type plant lamp achieves free combination of lamp bodies, and is expanded in use scenes, and reduced in use cost.

To achieve the above objectives, the present utility model adopts the following technical scheme.

A novel splicing type plant lamp includes a power supply body and lamp bodies electrically connected with the power supply body, wherein first electrical assemblies are disposed on end portions of two ends of the power supply body correspondingly, and second electrical assemblies electrically connected with the first electrical assemblies are disposed on two ends of the lamp bodies correspondingly.

Preferably, the first electrical assemblies are disposed on two sides of the end portions correspondingly; each of the first electrical assemblies is composed of a buckle protection shell and a first electrode, wherein the first electrode is disposed in the buckle protection shell, and the first electrode and the buckle protection shell are connected with the second electrical assembly separately; and a buckling flange is so disposed on one side of each buckle protection shell that one end of the buckling flange is fixedly connected to the side face of the buckle protection shell, and the other end is a free end.

Preferably, the second electrical assemblies are disposed on sides opposite to the first electrical assemblies; each of the second electrical assemblies is composed of a clamping protection shell and a second electrode, wherein the second electrode is disposed in the clamping protection shell, and the first electrode and the second electrode are mutually connected in a plugged mode to form an electrical connection; and each of the clamping protection shells is provided with a concave area, and the buckling flange is inserted into the concave area to fasten the buckle protection shell and the clamping protection shell.

Preferably, the first electrodes may be male or female, and the second electrodes may be male or female.

Preferably, the lamp body is composed of a plurality of lamp bars, and the plurality of lamp bars are electrically connected with the second electrical assemblies.

Preferably, the novel splicing type plant lamp further includes a controller disposed on the power supply body, and the controller is configured to control illumination, illumination time and on-off of the lamp bodies.

A splicing type plant lamp with a built-in power supply includes lamp bodies each composed of lamp bars and a pair of cross beams, the lamp bodies being movably connected with each other, wherein a power supply body and a first electrical assembly electrically connected with the power supply body are disposed in each of the cross beams, the first electrical assembly is disposed at an end portion of one end of each of the cross beams, and the other lamp body movably connected with the lamp body is provided with second electrical assemblies which are matched and electrically connected with the first electrical assemblies.

Preferably, the first electrical assembly is composed of a buckle protection shell and a first electrode, wherein the first electrode is disposed in the buckle protection shell, and the first electrode and the buckle protection shell are connected with the second electrical assembly; and a buckling flange is so disposed on one side of the buckle protection shell that one end of the buckling flange is fixedly connected to the side face of the buckle protection shell, and the other end is a free end.

Preferably, the second electrical assemblies are disposed on sides opposite to the first electrical assemblies; each of the second electrical assemblies is composed of a clamping protection shell and a second electrode, wherein the second electrode is disposed in the clamping protection shell, and the first electrode and the second electrode are mutually connected in a plugged mode to form an electrical connection; and each of the clamping protection shells is provided with a concave area, and the buckling flange is inserted into the concave area to fasten the buckle protection shell and the clamping protection shell.

Preferably, the first electrodes may be male or female, and the second electrodes may be male or female.

Preferably, the novel splicing type plant lamp further includes a controller disposed on the power supply body, and the controller is configured to control illumination, illumination time and on-off of the lamp bodies.

A plant lamp capable of being rapidly disassembled and assembled includes two supporting shells and six lamp bodies, wherein six connecting bases are fixedly disposed in each of the two supporting shells, six shell openings matched with the connecting bases are formed in a top end of each of the two supporting shells, a clamping groove is formed in a top end of each of the connecting bases, a female plug-in electrode is fixedly disposed on one side of each of the connecting bases, a connecting cover is connected to a top end of each of the connecting bases in a clamped mode, a connecting clamping block clamped with the clamping groove is fixedly disposed on an inner wall of a top end of each of the connecting covers, a male plug-in electrode is fixedly disposed at a bottom end of each of the connecting clamping blocks, an electrode plug matched with the female plug-in electrode is disposed at a bottom end of each of the male plug-in electrodes, a connecting groove is fixedly disposed on one side of each of the connecting covers, every two connecting covers form a group, one lamp body is connected between the connecting covers in each group in a clamped mode, the lamp bodies are electrically connected with the corresponding electrode plugs through electric wires, two mounting rods are fixedly disposed on one side of each of the two supporting shells, each of the mounting rods includes two connecting sleeves and two telescopic columns sliding in the connecting sleeves, a mounting plate is fixedly disposed at top ends of the two connecting sleeves, fixing pieces are fixedly disposed at two ends of each of the mounting plates, and a fixing hole is formed in the middle of each of the fixing pieces.

As a preferred technical scheme of the present utility model, a plurality of evenly spaced threaded holes are formed in one side of each of the telescopic columns, and a fixing bolt matched with the threaded holes is in threaded connection with a bottom of one side of each of the connecting sleeves.

As a preferred technical scheme of the present utility model, the supporting shell further includes a power supply connecting column, the power supply connecting column is fixedly disposed in the middle of one of the supporting shells, and the power supply connecting column is electrically connected with the corresponding female plug-in electrodes.

As a preferred technical scheme of the present utility model, the supporting shell is of a hollow structure.

As a preferred technical scheme of the present utility model, a plurality of reinforcing ribs are fixedly disposed at a top of one side of each of the connecting covers, and the reinforcing ribs and the corresponding connecting groove are disposed as an integrated structure.

As a preferred technical scheme of the present utility model, a wire hole is formed in a side wall of the connecting groove.

A plant lamp capable of infinitely extending and adjusting an irradiation angle to achieve a variable PPF value includes lamp bodies and adapter blocks disposed at two end portions of the lamp bodies, wherein rotating shafts are rotationally connected to two ends of the lamp bodies, fixing discs corresponding to the rotating shafts are fixedly disposed in the adapter blocks, a first bump is fixedly disposed at one end of each of the adapter blocks, a first female plug is disposed at one end of each of the first bumps, a first groove clamped with the corresponding first bump is formed in the other end of each of the adapter blocks, a male plug matched with the first female plug is fixedly disposed in each of the first grooves, a power supply connector and a tail sealing head are connected with two ends of each of the adapter blocks in a clamped mode correspondingly, a handle is fixedly disposed on one side of each of the adapter blocks, each of the handles includes two connecting sleeves and two telescopic columns sliding in the connecting sleeves, the two telescopic columns are fixedly disposed on one side of each of the adapter blocks, a connecting column is fixedly disposed at top ends of the two connecting sleeves, mounting pieces are fixedly disposed at two ends of each of the connecting columns, a mounting hole is fixedly formed in the middle of each of the mounting pieces, a fixing bolt is in threaded connection with a bottom of one side of each of the connecting sleeves, and a plurality of threaded holes matched with the fixing bolt are formed in one side of each of the telescopic columns.

As a preferred technical scheme of the present utility model, a second bump clamped with the first groove is fixedly disposed on one end of the power supply connector, a second female plug matched with the male plug is disposed at one end of the second bump, and an electric wire connecting column electrically connected with the second female plug is fixedly disposed on one side of the power supply connector.

As a preferred technical scheme of the present utility model, a second groove clamped with the first bump is formed in one end of the tail sealing head.

As a preferred technical scheme of the present utility model, the rotating shafts are fixedly connected with the corresponding fixing discs through the fixing bolts.

As a preferred technical scheme of the present utility model, a clamping block is fixedly disposed on one side of a bottom end of each of the telescopic columns, and a clamping groove clamped with the clamping block is formed in one side of each of the adapter blocks.

As a preferred technical scheme of the present utility model, first wire holes are formed in two ends of each of the lamp bodies, and a second wire hole is formed in one side of each of the fixing discs.

The novel plant lamp provided by the present utility model has the beneficial effects as follows:

1) The problems of complex assembly and difficult disassembly of the plant lamp can be effectively avoided, and the transportation cost and labor intensity are reduced, so that the disassembly and assembly efficiency of the plant lamp is improved, the working efficiency is improved, the product competitiveness of the plant lamp is improved, and the efficiency of supplementing light to the plants is improved.

2) Different lamp bars can be freely combined, for example, the lamp body composed of three lamp bars is disposed on one side of the power supply body, and the lamp body composed of four lamp bars can be disposed on the other side of the power supply body, so that the plant lamp is suitable for different use scenes.

### BRIEF DESCRIPTION OF FIGURES

FIG. 1 is a schematic structure diagram of the present utility model.

FIG. 2 is a schematic structure diagram of a power supply body in FIG. 1.

FIG. 3 is a schematic structure diagram of a first electrical assembly in FIG. 1.

FIG. 4 is a schematic structure diagram of the first electrical assembly in FIG. 3.

FIG. 5 is a schematic structure diagram of the first electrical assembly in FIG. 3.

FIG. 6 is a schematic structure diagram of a second electrical assembly in FIG. 1.

FIG. 7 is a schematic structure diagram of the second electrical assembly in FIG. 1.

FIG. 8 is a schematic structure diagram of the present utility model.

FIG. 9 is a schematic structure diagram of a power supply body in FIG. 8.

FIG. 10 is a schematic structure diagram of a first electrical assembly in FIG. 8.

FIG. 11 is a schematic structure diagram of the first electrical assembly in FIG. 10.

FIG. 12 is a schematic structure diagram of the first electrical assembly in FIG. 10.

FIG. 13 is a schematic structure diagram of a second electrical assembly in FIG. 8.

FIG. 14 is a schematic structure diagram of the second electrical assembly in FIG. 8.

FIG. 15 is a schematic structure diagram of the present utility model.

FIG. 16 is a schematic diagram of a partial structure of a supporting shell of the present utility model.

FIG. 17 is a schematic structure diagram of a connecting cover of the present utility model.

FIG. 18 is a schematic diagram of a lateral structure of the connecting cover of the present utility model.

FIG. 19 is a schematic structure diagram of the present utility model.

FIG. 20 is a schematic structure diagram of a drying box adapter block of the present utility model.

FIG. 21 is a schematic diagram of an internal structure of the adapter block of the present utility model.

FIG. 22 is a schematic structure diagram of a power supply connector of the present utility model.

FIG. 23 is a schematic structure diagram of a tail sealing head of the present utility model.

FIG. 24 is a schematic structure diagram of a rotating shaft of the present utility model.

FIG. 25 is a schematic structure diagram of a clamping block of the present utility model.

### DETAILED DESCRIPTION

The present utility model will be further described below with reference to the accompanying drawings, it should be noted that the following embodiments give out detailed implementation modes and specific operation process on the basis of the technical scheme provided by the present utility model, but the protection scope of the present utility model is not limited to the embodiments.

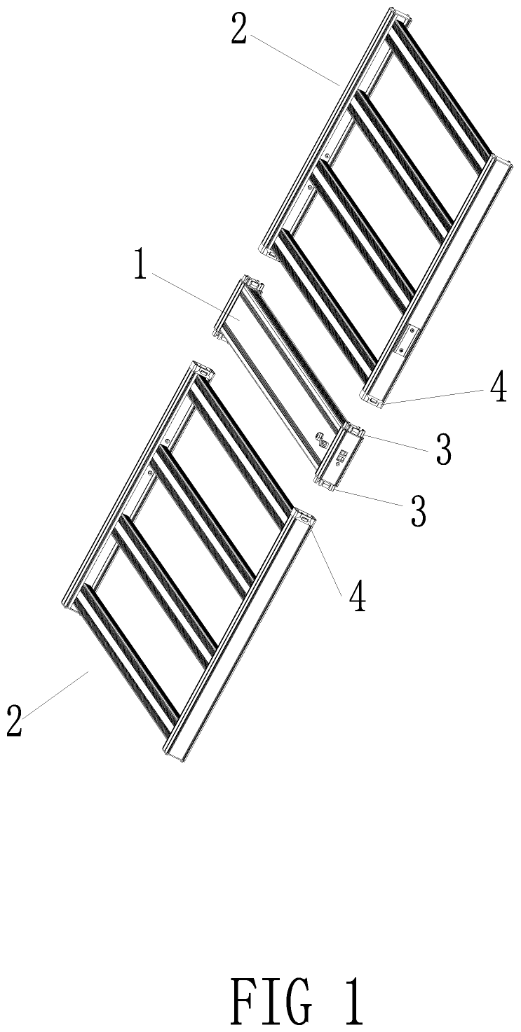

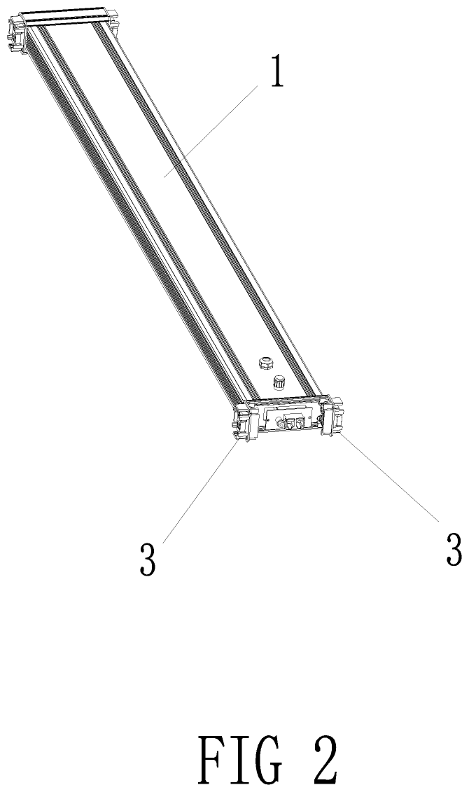

As shown in FIG. 1 and FIG. 2, the present utility model discloses a novel splicing type plant lamp which is provided with a power supply body 1 and lamp bodies 2 electrically connected with the power supply body 1. First electrical assemblies 3 are disposed on end portions of two ends of the power supply body 1 correspondingly. Second electrical assemblies 4 electrically connected with the first electrical assemblies 3 are disposed on two ends of the lamp bodies correspondingly.

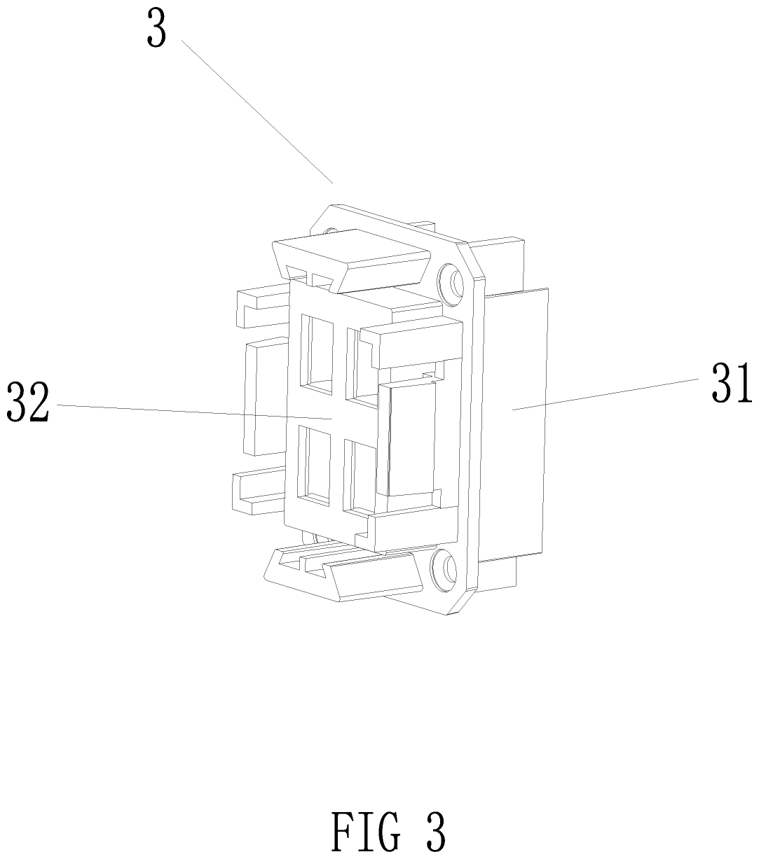

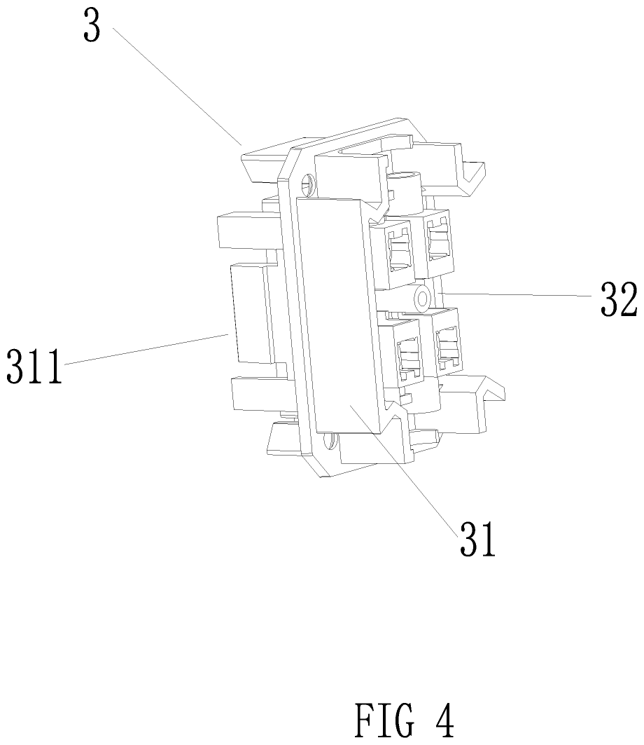

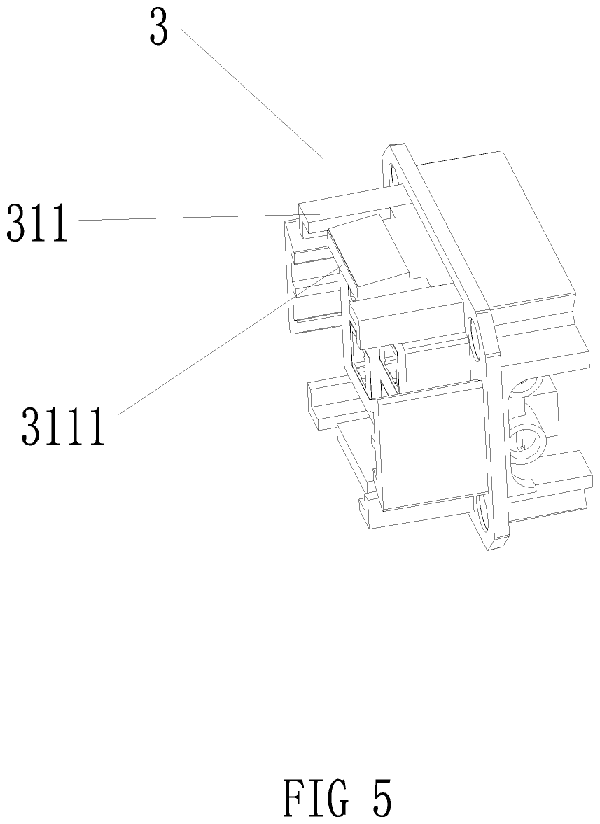

Furthermore, as shown in FIG. 3, FIG. 4 and FIG. 5, the first electrical assemblies 3 are disposed on the two sides of the end portions correspondingly. Each of the first electrical assemblies 3 is composed of a buckle protection shell 31 and a first electrode 32. The first electrode 32 is disposed in the buckle protection shell 31. The first electrode 32 and the buckle protection shell 31 are connected with the second electrical assembly separately. A buckling flange 311 is so disposed on one side of each buckle protection shell 31 that one end of the buckling flange 311 is fixedly connected to the side face of the buckle protection shell 31, and the other end is a free end 3111.

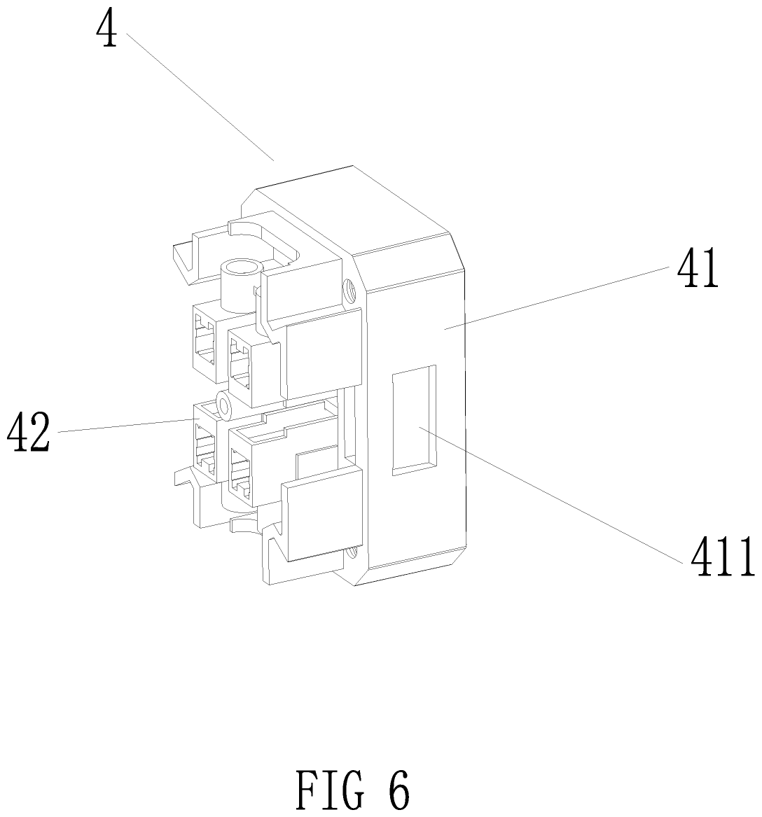

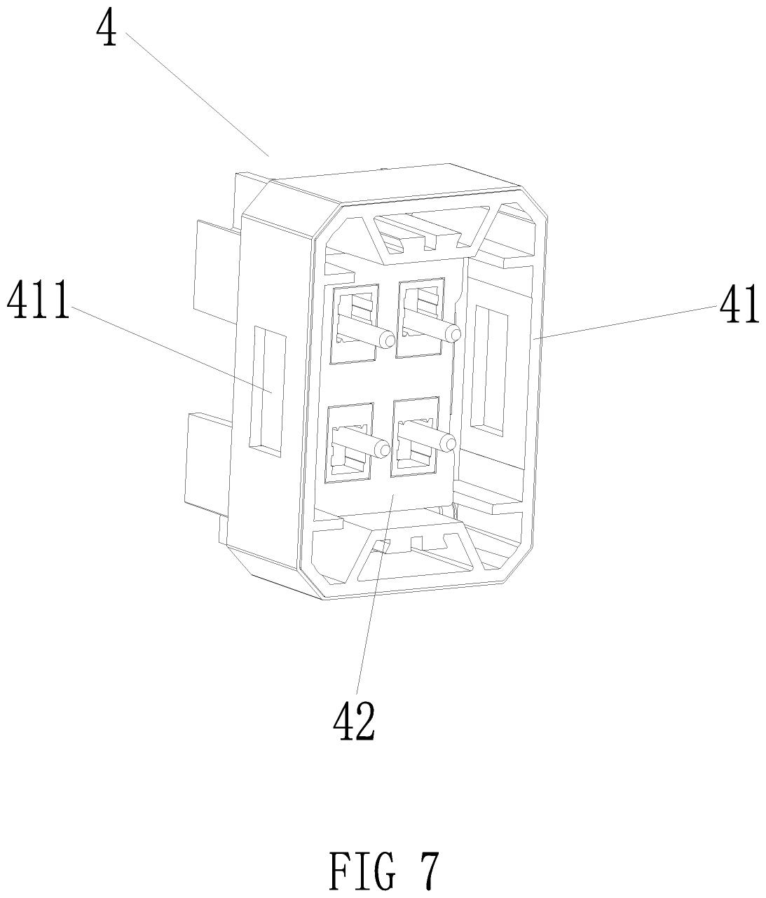

Furthermore, as shown in FIG. 6 and FIG. 7, the second electrical assemblies 4 are disposed on sides opposite to the first electrical assemblies. Each of the second electrical assemblies 4 is composed of a clamping protection shell 41 and a second electrode 42. The second electrode 42 is disposed in the clamping protection shell 41. The first electrode and the second electrode are mutually connected in a plugged mode to form an electrical connection. Each of the clamping protection shells 41 is provided with a concave area 411. The buckling flange is inserted into the concave area 411 to fasten the buckle protection shell and the clamping protection shell 41.

It should be further explained that when the buckle protection shells are inserted into the clamping protection shells, the free ends deform under extrusion, and after the free ends are buckled into the concave areas, the deformation of the free ends is eliminated, so that the buckle protection shells are connected with the clamping protection shells.

As a preferred technical scheme, the first electrodes may be male or female, and the second electrodes may be male or female.

It should be noted that the lamp body described by the present utility model is composed of a plurality of lamp bars, and the plurality of lamp bars are electrically connected with the second electrical assemblies.

Furthermore, the novel splicing type plant lamp further includes a controller disposed on the power supply body, and the controller is configured to control illumination, illumination time and on-off of the lamp bodies.

It should be noted that for ease of plugging the buckle protection shells into the clamping protection shells, the sizes of the buckle protection shells are slightly smaller than those of the clamping protection shells.

### Embodiment

The working principle of the plant lamp is as follows: The lamp bodies suitable for a scene are selected, and then the first electrical assemblies on the power supply body and the second electrical assemblies on the lamp body are connected in a plugged mode and paired to complete assembly. When the lamp needs to be transported or disassembled, the power supply body and the lamp bodies can be directly disassembled, which is convenient for loading or transporting, and saves space and manpower.

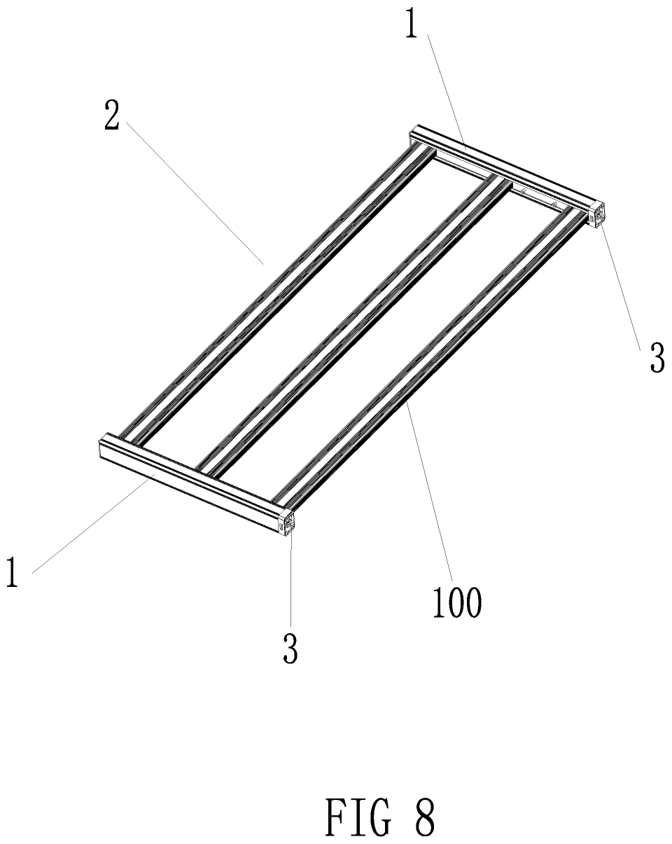

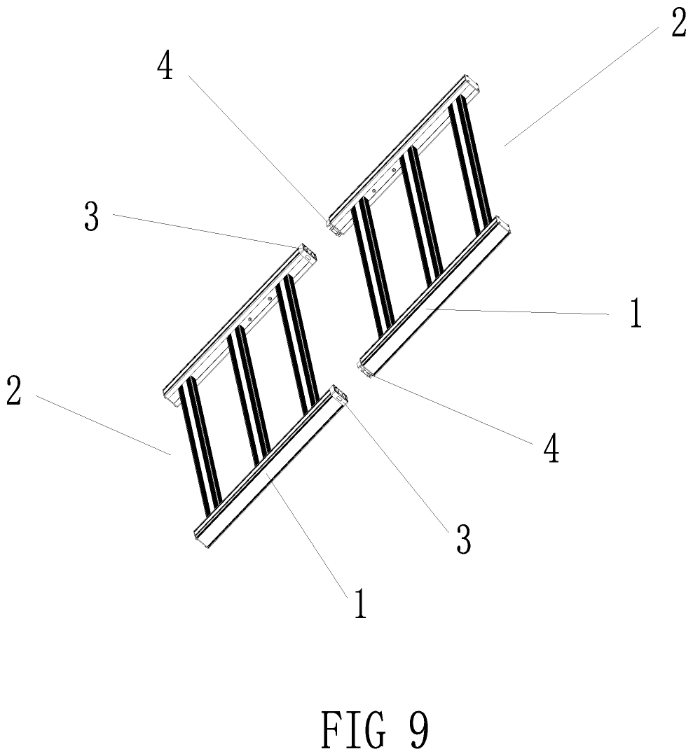

As shown in FIG. 8 and FIG. 9, a splicing type plant lamp with a built-in power supply includes lamp bodies 2 each composed of lamp bars 100 and a pair of cross beams 1. The lamp bodies 2 are movably connected with each other. A power supply body and a first electrical assembly 3 electrically connected with the power supply body are disposed in each of the cross beams 1. The first electrical assembly 3 is disposed at an end portion of one end of each of the cross beams 1. The other lamp body 2 movably connected with the lamp body 2 is provided with second electrical assemblies 4 which are matched and electrically connected with the first electrical assemblies 3.

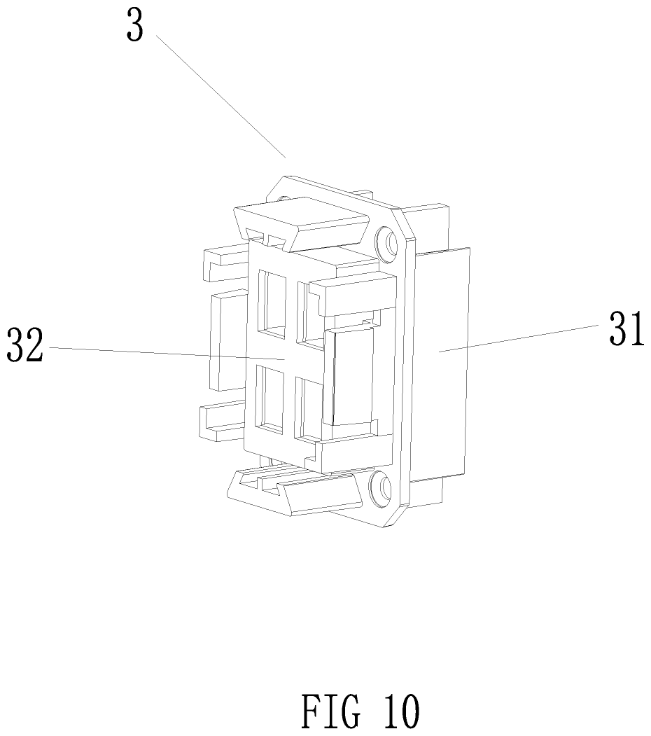

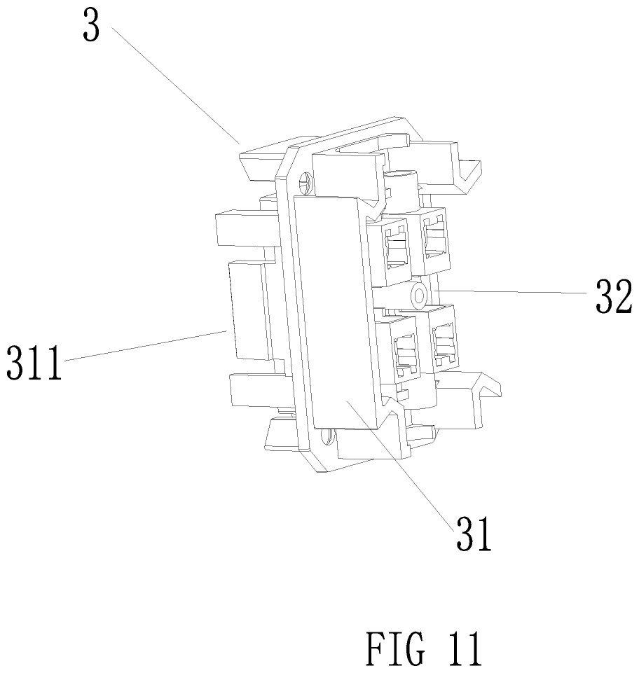

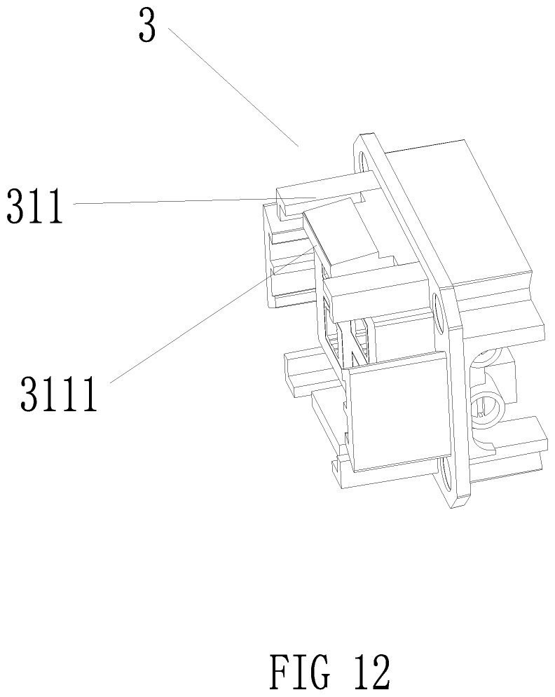

Furthermore, as shown in FIG. 10, FIG. 11 and FIG. 12, the first electrical assemblies 3 are disposed on two sides of the end portions correspondingly. Each of the first electrical assemblies 3 is composed of a buckle protection shell 31 and a first electrode 32. The first electrode 32 is disposed in the buckle protection shell 31. The first electrode 32 and the buckle protection shell 31 are connected with the second electrical assembly. A buckling flange 311 is so disposed on one side of each buckle protection shell 31 that one end of the buckling flange 311 is fixedly connected to the side face of the buckle protection shell 31, and the other end is a free end 3111.

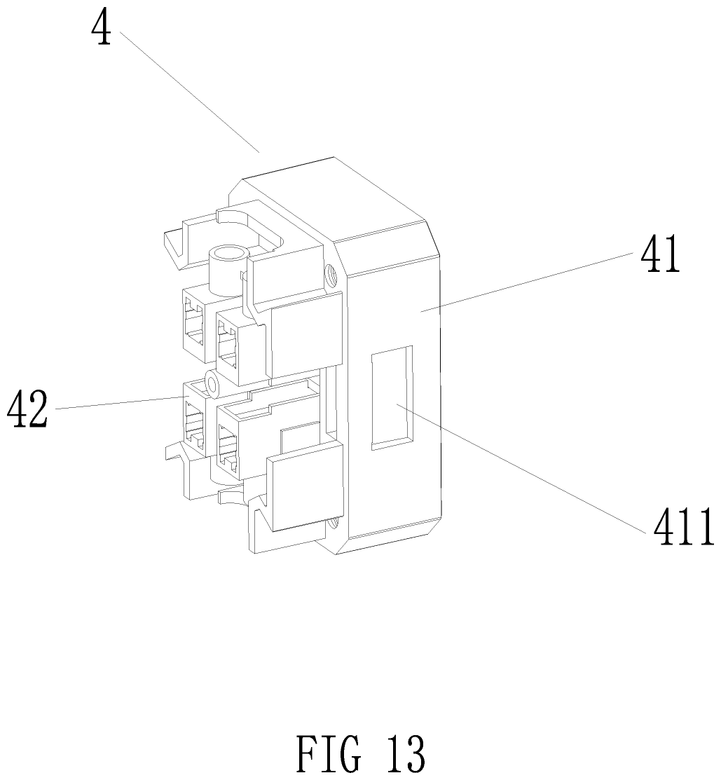

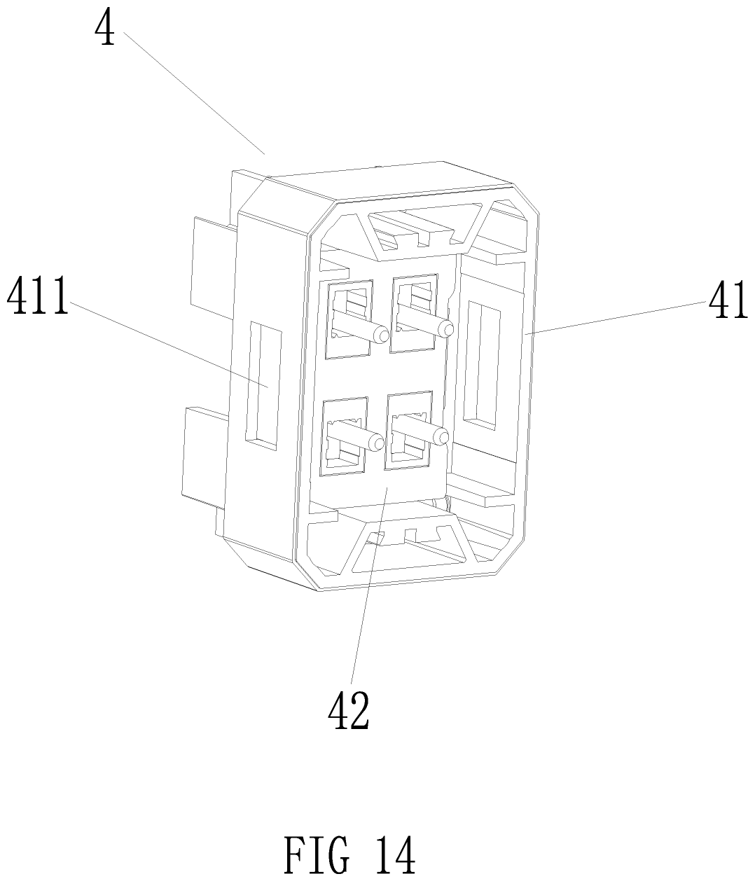

Furthermore, as shown in FIG. 13 and FIG. 14, the second electrical assemblies 4 are disposed on sides opposite to the first electrical assemblies. Each of the second electrical assemblies 4 is composed of a clamping protection shell 41 and a second electrode 42. The second electrode 42 is disposed in the clamping protection shell 41. The first electrode and the second electrode are mutually connected in a plugged mode to form an electrical connection. Each of the clamping protection shells 41 is provided with a concave area 411. The buckling flange is inserted into the concave area 411 to fasten the buckle protection shell and the clamping protection shell 41.

It should be further explained that when the buckle protection shells are inserted into the clamping protection shells, the free ends deform under extrusion, and after the free ends are buckled into the concave areas, the deformation of the free ends is eliminated, so that the buckle protection shells are connected with the clamping protection shells.

As a preferred technical scheme, the first electrodes may be male or female, and the second electrodes may be male or female.

Furthermore, the novel splicing type plant lamp further includes a controller disposed on the power supply body, and the controller is configured to control illumination, illumination time and on-off of the lamp bodies.

It should be noted that for ease of plugging the buckle protection shells into the clamping protection shells, the sizes of the buckle protection shells are slightly smaller than those of the clamping protection shells.

### Embodiment

The working principle of the plant lamp is as follows: The lamp bodies suitable for a scene are selected, and then the first electrical assemblies on the cross beams of one lamp body and the second electrical assemblies on the other lamp body are connected in a plugged mode and paired to complete assembly. If diffraction needs to continue, the steps above are repeated.

When the lamp needs to be transported or disassembled, the single lamp body can be directly disassembled, which facilitates loading or transporting, and saves space and manpower.

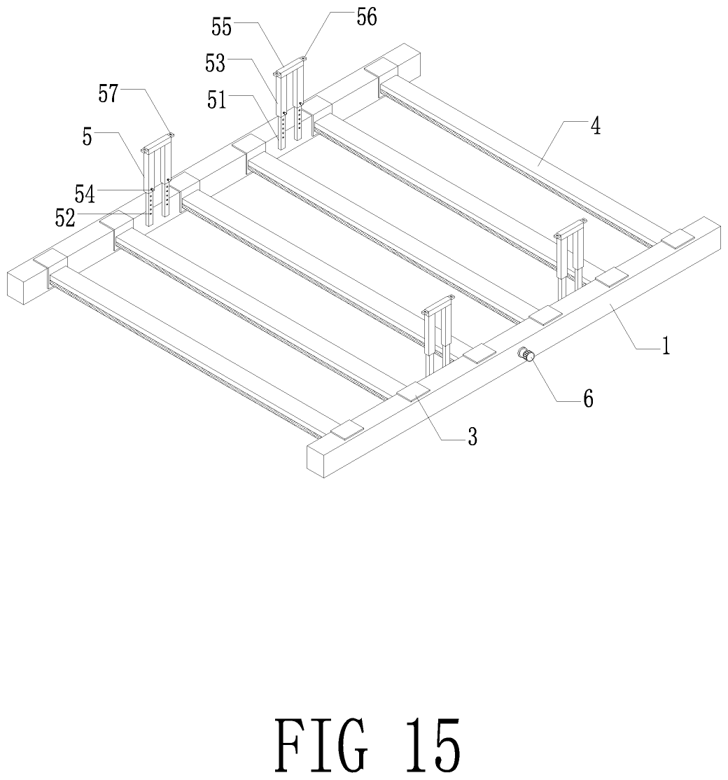

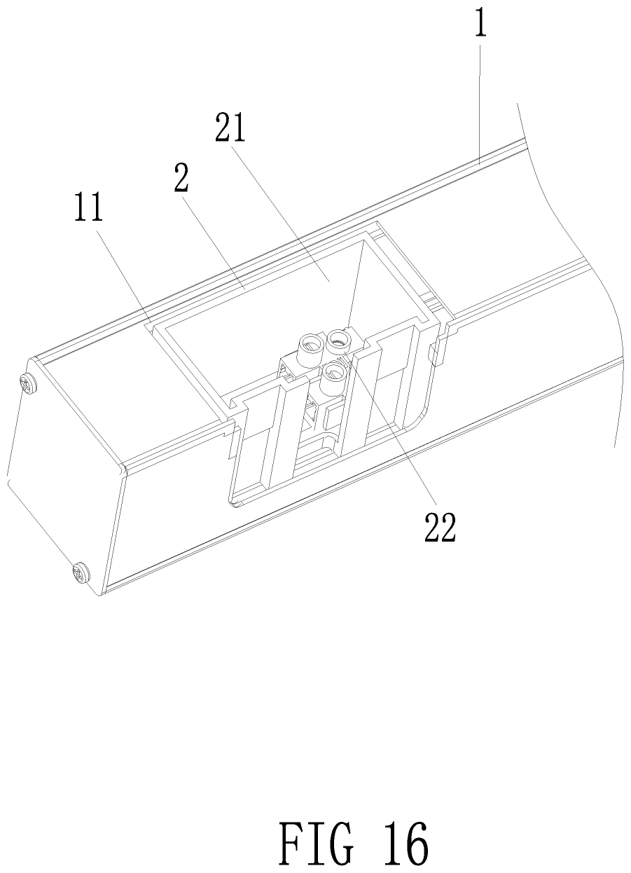

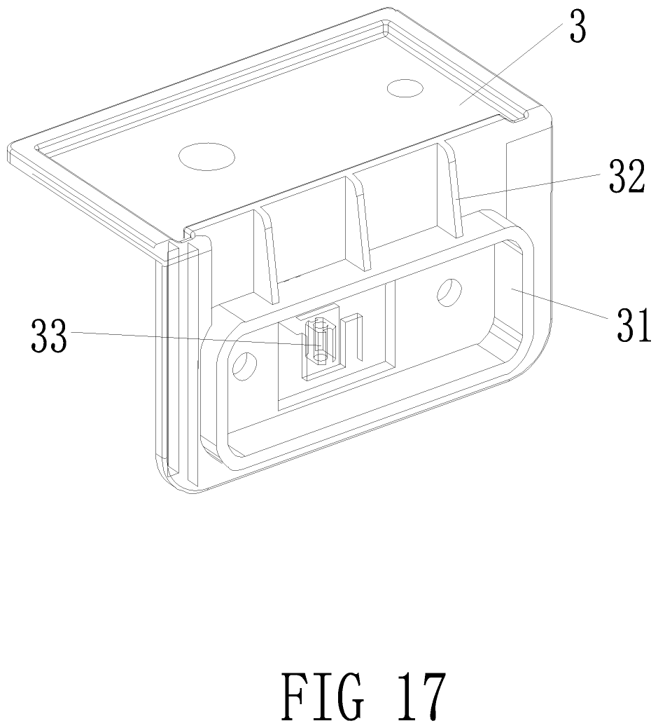

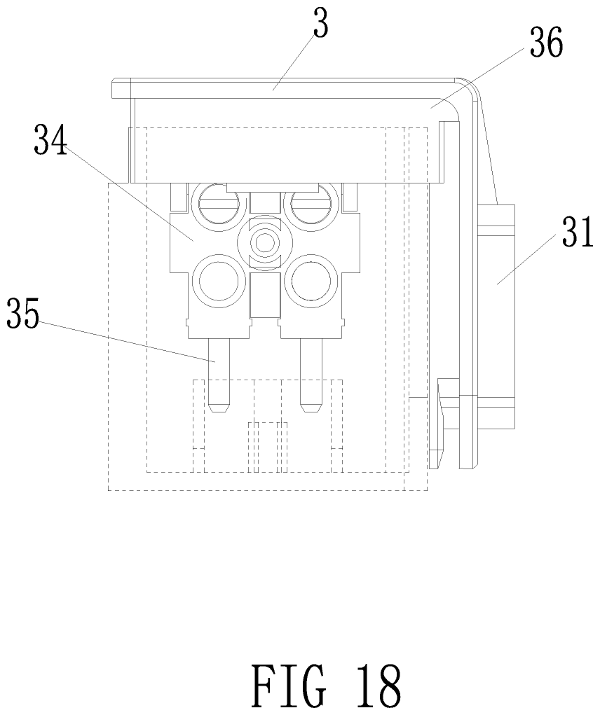

Referring to FIG. 15 to FIG. 18, the present utility model provides a plant lamp capable of being rapidly disassembled and assembled, including two supporting shells 1 and six lamp bodies 4. Six connecting bases 2 are fixedly disposed in each of the two supporting shells 1. Six shell openings 11 matched with the connecting bases 2 are formed in a top end of each of the two supporting shells 1. A clamping groove 21 is formed in a top end of each of the connecting bases 2. A female plug-in electrode 22 is fixedly disposed on one side of each of the connecting bases 2. A connecting cover 3 is connected to a top end of each of the connecting bases 2 in a clamped mode. A connecting clamping block 36 clamped with the clamping groove 21 is fixedly disposed on an inner wall of a top end of each of the connecting covers 3. A male plug-in electrode 34 is fixedly disposed at a bottom end of each connecting clamping block 36. An electrode plug 35 matched with the female plug-in electrode 22 is disposed at a bottom end of each of the male plug-in electrodes 34. A connecting groove 31 is fixedly disposed on one side of each of the connecting covers 3. Every two connecting covers 3 form a group. One lamp body 4 is connected between the connecting covers 3 in each group in a clamped mode. The lamp bodies 4 are electrically connected with the corresponding electrode plugs 35 through electric wires. Two mounting rods 5 are fixedly disposed on one side of each of the two supporting shells 1. Each of the mounting rods 5 includes two connecting sleeves 53 and two telescopic columns 51 sliding in the connecting sleeves 53. A mounting plate 55 is fixedly disposed at top ends of the two connecting sleeves 53. Fixing pieces 56 are fixedly disposed at two ends of each of the mounting plates 55. A fixing hole 57 is formed in the middle of each of the fixing pieces 56. Therefore, the lamp can be conveniently assembled.

Preferably, a plurality of evenly spaced threaded holes 52 are formed in one side of each of the telescopic columns 51, a fixing bolt 54 matched with the threaded holes 52 is in threaded connection with a bottom of one side of each of the connecting sleeves 53, and the fixing bolts 54 are in threaded connection with the corresponding threaded holes 52, so that the positions of the telescopic columns 51 are fixed. The supporting shell 1 further includes a power supply connecting column 6. The power supply connecting column 6 is fixedly disposed in the middle of one of the supporting shells 1. The power supply connecting column 6 is electrically connected with the corresponding female plug electrodes 22. The lamp can emit light by switching on a power supply through the power supply connecting column 6. The supporting shell 1 is of a hollow structure and is configured to accommodate electric wires connected between the lamp bodies 4 and the connecting covers 3. A plurality of reinforcing ribs 32 are fixedly disposed at a top of one side of each of the connecting covers 3. The reinforcing ribs 32 and the corresponding connecting groove 31 are disposed as an integrated structure and configured to effectively reinforce the connecting strength of the connecting groove 31 and the connecting cover 3 and reinforce the structural strength of the connecting groove 31, and the phenomenon that the connecting groove 31 is prone to being damaged due to the fact that the connecting groove 31 bears the overweight lamp body 4 is prevented. A wire hole 33 is formed in the side wall of the connecting groove 31, which is convenient for the electric wire of the lamp body 4 to pass through.

During specific use, when the plant lamp capable of being rapidly disassembled and assembled provided by the present utility model is assembled, the two ends of each lamp body 4 are clamped through the connecting grooves 31 of the connecting covers 3 correspondingly, and the lamp body 4 is electrically connected with the corresponding male plug-in electrodes 34 through the electric wires, so that the two connecting covers 3 are connected into the clamping grooves 21 of the connecting bases 2 of the two supporting shells 1 in a clamped mode. At the moment, the electrode plugs 35 of the male plug-in electrodes 34 are plugged into the female plug-in electrodes 22, the connecting covers 3 are connected with the electrodes of the connecting bases 2, and therefore, the lamp body 4 can be electrically connected with a power supply. Meanwhile, according to different illumination conditions required by plants, the number of the used lamp bodies 4 is increased or decreased. At the moment, the plant lamp is assembled at the place needing to be irradiated through the mounting rods 5, the lengths of the mounting rods 5 can be adjusted according to the actual situation, the positions of the telescopic columns 51 in the connecting sleeves 53 are adjusted, and the telescopic columns 51 are in threaded connection with the corresponding threaded holes 52 through the fixing bolts 54, so that the positions of the telescopic columns 51 are fixed. Then the power supply connecting column 6 is connected with the power supply, so that the lamp can emit light to irradiate the plants. When the lamp needs to be transported or disassembled, only the connecting covers 3 need to be removed from the connecting bases 2, and thus the plant lamp can be conveniently loaded or transported, and space and labor are saved.

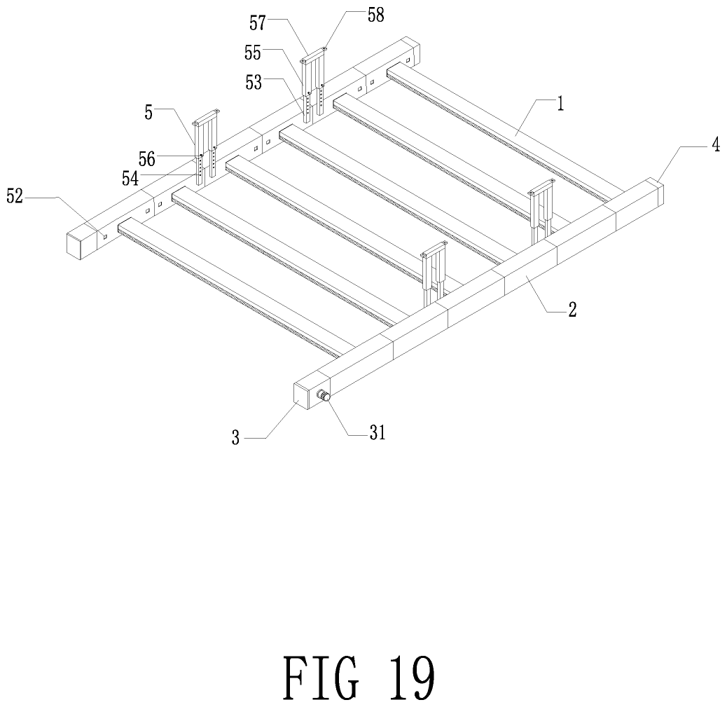

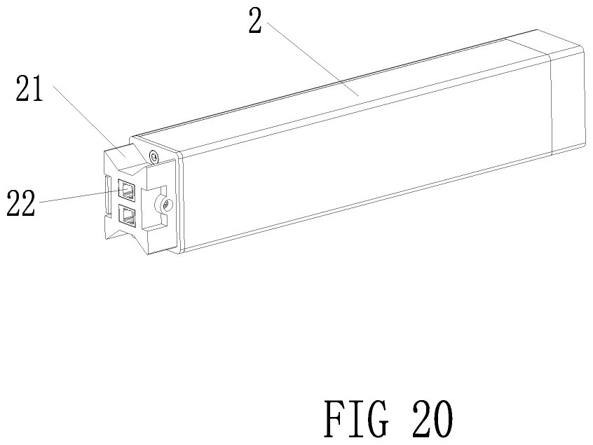

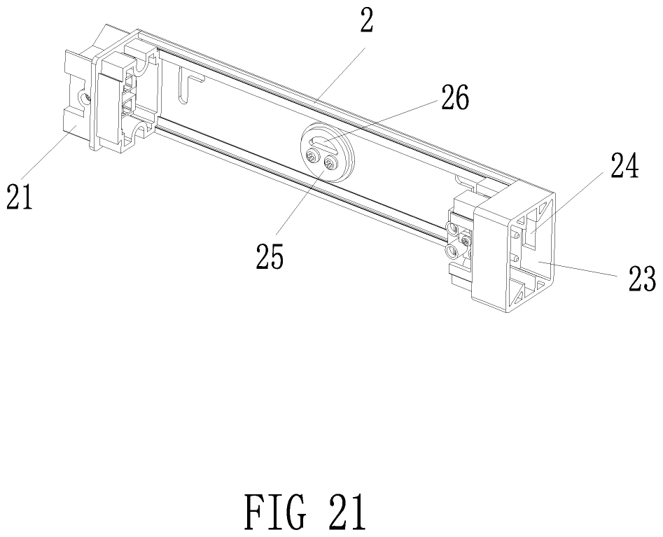

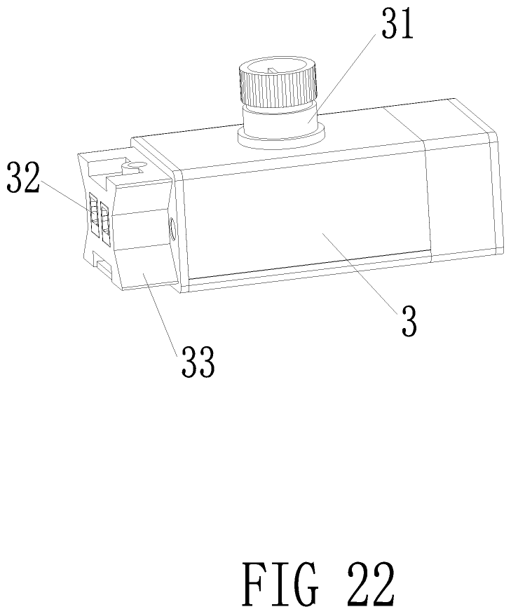

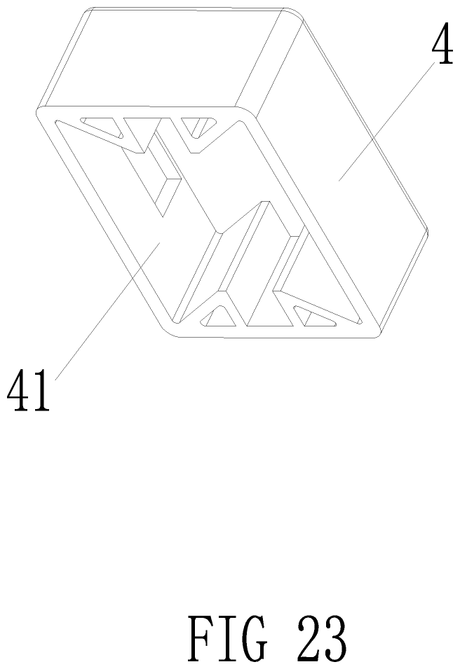

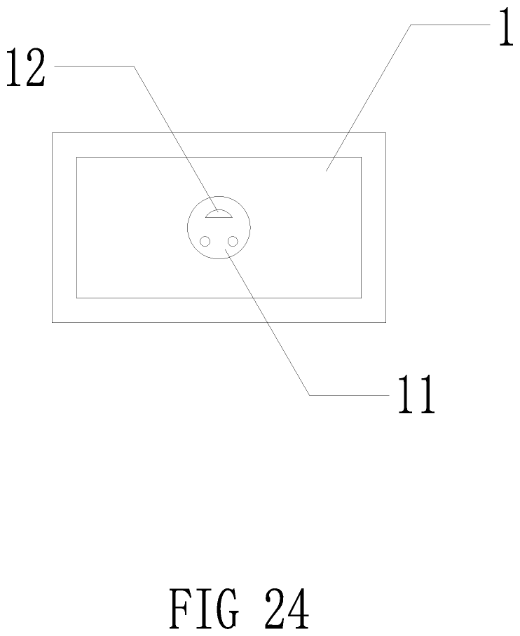

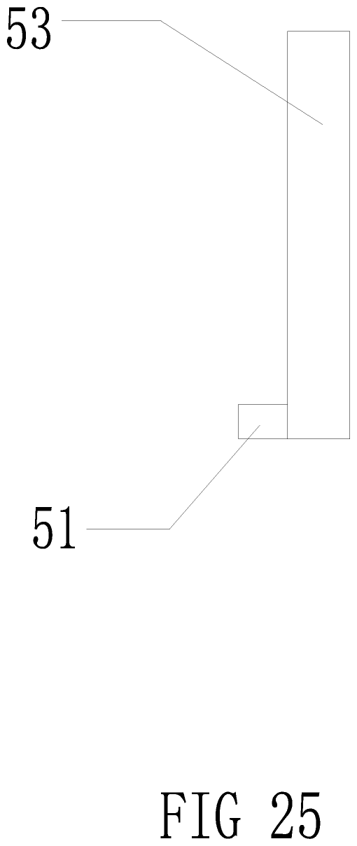

Referring to FIG. 19 to FIG. 25, the present utility model provides a plant lamp capable of infinitely extending and adjusting an irradiation angle to achieve a variable PPF value, including lamp bodies 1 and adapter blocks 2 disposed at two end portions of the lamp bodies 1. Rotating shafts 11 are rotationally connected to two ends of the lamp bodies 1. Fixing discs 25 corresponding to the rotating shafts 11 are fixedly disposed in the adapter blocks 2. A first bump 21 is fixedly disposed at one end of each of the adapter blocks 2. A first female plug 22 is disposed at one end of each of the first bumps 21. A first groove 23 clamped with the corresponding first bump 21 is formed in the other end of each of the adapter blocks 2. A male plug 24 matched with the first female plug 22 is fixedly disposed in each of the first grooves 23. A power supply connector 3 and a tail sealing head 4 are connected with two ends of each of the adapter blocks 2 in a clamped mode correspondingly. A handle 5 is fixedly disposed on one side of each of the adapter blocks 2. The plant lamp can be hung above plants through the handles 5 for irradiation. Each of the handles 5 includes two connecting sleeves 55 and two telescopic columns 53 sliding in the connecting sleeves 55. The two telescopic columns 53 are fixedly disposed on one side of each of the adapter blocks 2. A connecting column 57 is fixedly disposed at top ends of the two connecting sleeves 55. Mounting pieces 58 are fixedly disposed at two ends of each of the connecting columns 57. A mounting hole is fixedly formed in the middle of each of the mounting pieces 58. A fixing bolt 56 is in threaded connection with a bottom of one side of each of the connecting sleeves 55. A plurality of threaded holes 54 matched with the fixing bolt 56 are formed in one side of each of the telescopic columns 53.

Preferably, a second bump 33 clamped with the first groove 23 is fixedly disposed at one end of the power supply connector 3. A second female plug 32 matched with the male plug 24 is disposed at one end of the second bump 33. An electric wire connecting column 31 electrically connected with the second female plug 32 is fixedly disposed on one side of the power supply connector 3. The second female plug 32 in the second bump 33 of the power supply connector 3 is also connected with the male plug 24 of the corresponding adapter block 2 to be electrified. The electric wire connecting column 31 is disposed on one side of the power supply connector 3 and then is connected with an external power supply, so that the whole plant lamp can be electrified to work. A second groove 41 clamped with the first bump 21 is formed in one end of the tail sealing head 4, and through clamping of the second groove 41 of the tail sealing head 4 and the first bump 21, the tail sealing head 4 can be conveniently assembled. The rotating shafts 11 are fixedly connected with the corresponding fixing discs 25 through fixing bolts 56. A clamping block 51 is fixedly disposed on one side of a bottom end of the telescopic column 53, and a clamping groove 52 clamped with the clamping block 51 is formed in one side of the corresponding adapter block 2, so that the handle 5 is convenient to disassemble and assemble. First wire holes 12 are formed in the two ends of each of the lamp bodies 1, and a second wire hole 26 is formed in one side of each of the fixing discs 25, so that an electric wire of the lamp body 1 can pass through the wire holes conveniently.

During specific use of the plant lamp capable of infinitely extending and adjusting the irradiation angle to achieve the variable PPF value provided by the present utility model, firstly, the electric wire of each lamp body 1 sequentially passes through the first wire holes 12 and the second wire holes 26 and is electrically connected with the male plugs 24 and the first female plugs 22 of the corresponding adapter blocks 2. Then the first groove 23 formed in one adapter block 2 is matched with the first bump 21 of the other adapter block 2, so that the male plug 24 in the first groove 23 is matched with the first female plug 22, and the lamp bodies 1 are electrified. The power supply connector 3 is mounted at one end of each adapter block 2, and the tail sealing head 4 is mounted at the other end of the adapter block 2. The second female plug 32 in the second bump 33 of each power supply connector 3 is also connected with the male plug 24 of the corresponding adapter block 2 to be electrified. An electric wire connecting column 31 is disposed on one side of each power supply connector 3 and then is connected with an external power supply, so that the whole plant lamp can be electrified to work, therefore, the plant lamp is of a splicing type structure, and the plant lamp is convenient to assemble and disassemble. The number of the lamp bodies 1 can be selected according to the size of the planting area, so that the plant lamp is more convenient to assemble, the problem that the whole plant lamp needs to be disassembled if the irradiation range needs to be replaced in a use process is avoided, the assembly efficiency is improved, and the labor intensity is reduced. The lamp bodies 1 are rotationally connected with the adapter blocks 2 through the rotating shafts 11, so that the lamp bodies 1 can be rotationally adjusted on the adapter blocks 2. The irradiation position and the irradiation angle of the plant lamp can be adjusted, and the illumination angle and the illumination range can be adjusted according to the characteristics of the plants, and thus the illumination range and the illumination intensity of the plant lamp can be rapidly and conveniently adjusted, and the application range is wider. The plant lamp can be hung above plants through the handles 5 for irradiation, and is convenient to disassemble and assemble. Each handle 5 is of an adjustable structure, and the plant lamp can be assembled at the irradiation position through the mounting pieces at the two ends of the connecting column 57.

For those skilled in the art, various corresponding modifications and variations may be made according to the above technical scheme and conception, and all the modifications and variations shall be included within the protection scope of the claims of the present utility model.

What is claimed is:

1. A novel splicing type plant lamp, comprising a power supply body and lamp bodies electrically connected with the power supply body, wherein first electrical assemblies are disposed on end portions of two ends of the power supply body correspondingly, and second electrical assemblies electrically connected with the first electrical assemblies are disposed on two ends of the lamp bodies correspondingly.

2. The novel splicing type plant lamp according to claim 1, wherein the first electrical assemblies are disposed on two sides of the end portions correspondingly; each of the first electrical assemblies is composed of a buckle protection shell and a first electrode, wherein the first electrode is disposed in the buckle protection shell, and the first electrode and the buckle protection shell are connected with the second electrical assembly separately; and a buckling flange is so disposed on one side of each buckle protection shell that one end of the buckling flange is fixedly connected to the side face of the buckle protection shell, and the other end is a free end.

3. The novel splicing type plant lamp according to claim 1, wherein the second electrical assemblies are disposed on sides opposite to the first electrical assemblies; each of the second electrical assemblies is composed of a clamping protection shell and a second electrode, wherein the second electrode is disposed in the clamping protection shell, and the first electrode and the second electrode are mutually connected in a plugged mode to form an electrical connection; and each of the clamping protection shells is provided with a concave area, and the buckling flange is inserted into the concave area to fasten the buckle protection shell and the clamping protection shell.

4. The novel splicing type plant lamp according to claim 3, wherein the first electrodes may be male or female, and the second electrodes may be male or female.

5. The novel splicing type plant lamp according to claim 1, wherein the lamp body is composed of a plurality of lamp bars, and the plurality of lamp bars are electrically connected with the second electrical assemblies.

6. The novel splicing type plant lamp according to claim 1, further comprising a controller disposed on the power supply body, and the controller is configured to control illumination, illumination time and on-off of the lamp bodies.

7. A splicing type plant lamp with a built-in power supply, comprising lamp bodies each composed of lamp bars and a pair of cross beams, the lamp bodies being movably connected with each other, wherein a power supply body and a first electrical assembly electrically connected with the power supply body are disposed in each of the cross beams, the first electrical assembly is disposed at an end portion of one end of each of the cross beams, and the other lamp body movably connected with the lamp body is provided with second electrical assemblies which are matched and electrically connected with the first electrical assemblies.

8. The splicing type plant lamp with the built-in power supply according to claim 7, wherein the first electrical assembly is composed of a buckle protection shell and a first electrode, wherein the first electrode is disposed in the buckle protection shell, and the first electrode and the buckle protection shell are connected with the second electrical assembly; and a buckling flange is so disposed on one side of the buckle protection shell that one end of the buckling flange is fixedly connected to the side face of the buckle protection shell, and the other end is a free end.

9. The novel splicing type plant lamp according to claim 7, wherein the second electrical assemblies are disposed on sides opposite to the first electrical assemblies; each of the second electrical assemblies is composed of a clamping protection shell and a second electrode, wherein the second electrode is disposed in the clamping protection shell, and the first electrode and the second electrode are mutually connected in a plugged mode to form an electrical connection; and each of the clamping protection shells is provided with a concave area, and the buckling flange is inserted into the concave area to fasten the buckle protection shell and the clamping protection shell.

10. The novel splicing type plant lamp according to claim 9, wherein the first electrodes may be male or female, and the second electrodes may be male or female.

11. The novel splicing type plant lamp according to claim 7, further comprising a controller disposed on the power supply body, and the controller is configured to control illumination, illumination time and on-off of the lamp bodies.

12. A plant lamp capable of being rapidly disassembled and assembled, comprising two supporting shells (1) and six lamp bodies (4), wherein six connecting bases (2) are fixedly disposed in each of the two supporting shells (1), six shell openings (11) matched with the connecting bases (2) are formed in a top end of each of the two supporting shells (1), a clamping groove (21) is formed in a top end of each of the connecting bases (2), a female plug-in electrode (22) is fixedly disposed on one side of each of the connecting bases (2), a connecting cover (3) is connected to a top end of each of the connecting bases (2) in a clamped mode, a connecting clamping block (36) clamped with the clamping groove (21) is fixedly disposed on an inner wall of a top end of each of the connecting covers (3), a male plug-in electrode (34) is fixedly disposed at a bottom end of each of the connecting clamping blocks (36), an electrode plug (35) matched with the female plug-in electrode (22) is disposed at a bottom end of each of the male plug-in electrodes (34), a connecting groove (31) is fixedly disposed on one side of each of the connecting covers (3), every two connecting covers (3) form a group, one lamp body (4) is connected between the connecting covers (3) in each group in a clamped mode, the lamp bodies (4) are electrically connected with the corresponding electrode plugs (35) through electric wires, two mounting rods (5) are fixedly disposed on one side of each of the two supporting shells (1), each of the mounting rods (5) comprises two connecting sleeves (53) and two telescopic columns (51) sliding in the connecting sleeves (53), a mounting plate (55) is fixedly disposed at top ends of the two connecting sleeves (53), fixing pieces (56) are fixedly disposed at two ends of each of the mounting plates (55), and a fixing hole (57) is formed in the middle of each of the fixing pieces (56).

13. The plant lamp capable of being rapidly disassembled and assembled according to claim 12, wherein a plurality of evenly spaced threaded holes (52) are formed in one side of each of the telescopic columns (51), and a fixing bolt (54) matched with the threaded holes (52) is in threaded connection with a bottom of one side of each of the connecting sleeves (53).

14. The plant lamp capable of being quickly disassembled and assembled according to claim 12, wherein the supporting shell (1) further comprises a power supply connecting column (6), the power supply connecting column (6) is fixedly disposed in the middle of one of the supporting shells (1), and the power supply connecting column (6) is electrically connected with the corresponding female plug-in electrodes (22).

15. The plant lamp capable of being quickly disassembled and assembled according to claim 12, wherein the supporting shell (1) is of a hollow structure.

16. The plant lamp capable of being quickly disassembled and assembled according to claim 12, wherein a plurality of reinforcing ribs (32) are fixedly disposed at a top of one side of each of the connecting covers (3), and the reinforcing ribs (32) and the corresponding connecting groove (31) are disposed as an integrated structure.

17. The plant lamp capable of being quickly disassembled and assembled according to claim 12, wherein a wire hole (33) is formed in a side wall of the connecting groove (31).

18. A plant lamp capable of infinitely extending and adjusting an irradiation angle to achieve a variable PPF value, comprising lamp bodies (1) and adapter blocks (2) disposed at two end portions of the lamp bodies (1), wherein rotating shafts (11) are rotationally connected to two ends of the lamp bodies (1), fixing discs (25) corresponding to the rotating shafts (11) are fixedly disposed in the adapter blocks (2), a first bump (21) is fixedly disposed at one end of each of the adapter blocks (2), a first female plug (22) is disposed at one end of each of the first bumps (21), a first groove (23) clamped with the corresponding first bump (21) is formed in the other end of each of the adapter blocks (2), a male plug (24) matched with the first female plug (22) is fixedly disposed in each of the first grooves (23), a power supply connector (3) and a tail sealing head (4) are connected with two ends of each of the adapter blocks (2) in a clamped mode correspondingly, a handle (5) is fixedly disposed on one side of each of the adapter blocks (2), each of the handles (5) comprises two connecting sleeves (55) and two telescopic columns (53) sliding in the connecting sleeves (55), the two telescopic columns (53) are fixedly disposed on one side of each of the adapter blocks (2), a connecting column (57) is fixedly disposed at top ends of the two connecting sleeves (55), mounting pieces (58) are fixedly disposed at two ends of each of the connecting columns (57), a mounting hole is fixedly formed in the middle of each of the mounting pieces (58), a fixing bolt (56) is in threaded connection with a bottom of one side of each of the connecting sleeves (55), and a plurality of threaded holes (54) matched with the fixing bolt (56) are formed in one side of each of the telescopic columns (53); the rotating shafts (11) are fixedly connected with the corresponding fixing discs (25) through the fixing bolts (56); a clamping block (51) is fixedly disposed on one side of a bottom end of each of the telescopic columns (53), and a clamping groove (52) clamped with the clamping block (51) is formed in one side of each of the adapter blocks (2); and first wire holes (12) are formed in two ends of each of the lamp bodies (1), and a second wire hole (26) is formed in one side of each of the fixing discs (25).

19. The plant lamp capable of infinitely extending and adjusting the irradiation angle to achieve the variable PPF value according to claim 18, wherein a second bump (33) clamped with the first groove (23) is fixedly disposed on one end of the power supply connector (3), a second female plug (32) matched with the male plug (24) is disposed at one end of the second bump (33), and an electric wire connecting column (31) electrically connected with the second female plug (32) is fixedly disposed on one side of the power supply connector (3).

20. The plant lamp capable of infinitely extending and adjusting the irradiation angle to achieve the variable PPF value according to claim 18, wherein a second groove (41) clamped with the first bump (21) is formed in one end of the tail sealing head (4).
